(19) United States
(12) Patent Application Publication
(10) Pub. No.: US 2015/0120774 A1
(43) Pub. Date: Apr. 30, 2015

(54) MODIFIED B+ TREE NODE SEARCHING METHOD AND APPARATUS

(71) Applicant: Industry-Academic Cooperation Foundation, Yonsei University, Seoul (KR)

(72) Inventors: Sang Hyun Park, Seoul (KR); Hong Chan Roh, Seoul (KR); Min Cheol Shin, Incheon (KR)

(21) Appl. No.: 13/881,337

(22) PCT Filed: Nov. 30, 2012
(86) PCT No.: PCT/KR2012/010299

§ 371 Date: Apr. 24, 2013

(30) Foreign Application Priority Data
Apr. 13, 2012 (KR) 10-2012-0038734

(51) Int. Cl. G06F 17/30

(52) U.S. Cl. CPC G06F 17/30504; G06F 17/30327
USPC 707/769

(57) ABSTRACT

Disclosed are a modified B+ tree node searching method and apparatus including setting a search range including one or more key values based on an input of a user; generating a pointer set including pointers for searching for child nodes based on the set search range; transmitting an I/O request in parallel by using the generated pointer set; and searching for data of a node corresponding to a request for the input based on the transmitted I/O request.

### TECHNICAL FIELD

The present invention relates to a modified B+ tree node searching method and apparatus, and more particularly, to a modified B+ tree node searching method and apparatus for transmitting an input/output (I/O) having a predetermined range for a key value of an input request in a memory chip based data storage device.

### BACKGROUND ART

An SSD refers to a storage device designed to permanently store data in a semiconductor flash memory. Since the SSD has no component actually operating at all, the SSD is different from a conventional hard disk drive and has a semiconductor memory array configuring an integrated circuit as a disk drive.

Such a method has several advantages in that a data transmission speed is significantly faster than that of the conventional hard disk drive. A search time and a delay time are also greatly reduced, and most users feel that a computer booting time becomes very fast. Since there is no component to be driven or broken, durability has strengthened and noise has been reduced.

However, unlike the conventional hard disk, a flash memory and a flash solid state drive (SSD) have problems in that read/write speeds are asymmetric and an available period of the SSD according to repeated writing requests is reduced when the flash memory and the flash SSD are applied to a database management system (DBMS). Accordingly, technologies to compensate for the above problems have been developed, and the use of the SSD in various fields such as the DBMS has increased.

### DISCLOSURE

### Technical Problem

The present invention has been made in an effort to provide a searching method which does not exceed system resources in searching for a node of a B+ tree by using a plurality of I/O based on internal parallelism of a flash SSD.

### Technical Solution

An exemplary embodiment of the present invention provides a modified B+ tree node searching method including: setting a search range including one or more key values based on an input of a user; generating a pointer set including pointers for searching for child nodes based on the set search range; transmitting an I/O request in parallel by using the generated pointer set; and searching for data of a node corresponding to a request for the input based on the transmitted I/O request.

The setting of the search range may include extracting a start value of the search range and an end value of the search range for the one or more key values based on the request for the input of the user; and setting a search range having the start value and the end value.

The generating of the pointer set may include extracting key values corresponding to the set search range; extracting associated pointers to search for child nodes related to the extracted key values; and setting a pointer set by the extracted associated pointers according to an I/O parameter set to calculate an available memory and a shape of a B+ tree.

The setting of the pointer set may include setting the pointer set by multiplying the I/O parameter set based on a maximum available memory use amount which can be used for performing a search and an index based on a height of the B+ tree including nodes for the search.

The transmitting of the I/O request may include simultaneously transmitting one or more asynchronous I/O requests to a data storage device by using a pointer included in the generated pointer set.

The searching for the data of the node may include searching for the data of the node by using a depth first search (DFS).

Another exemplary embodiment of the present invention provides a modified B+ tree node searching apparatus including: a search range setting unit for setting a search range including one or more key values based on an input of a user; a pointer set generator for generating a pointer set including pointers for searching for child nodes based on the set search range; an I/O request transmitter for transmitting an I/O request in parallel by using the generated pointer set; and a data search unit for searching for data of a node corresponding to a request of the input based on the transmitted I/O request.

### Advantageous Effects

According to the present invention, there is an effect of significantly improving a search speed in searching a B+ tree in comparison with a prior art.

### DESCRIPTION OF DRAWINGS

FIG. 1 is a reference diagram illustrating an internal structure of a flash solid state drive (SSD).

FIGS. 2 and 3 are reference diagrams measuring a delay time of a random input/output (read/write) according to an I/O size of the flash SSD.

FIGS. 4 to 6 are reference diagrams illustrating a benchmark result of the input/output (read/write) in an outstanding I/O level.

FIG. 7 is a reference diagram for describing an internal node structure for a B+ tree configuration.

FIG. 8 is a flowchart illustrating a modified B+ tree node searching method according to an exemplary embodiment of the present invention.

FIG. 9 is a detailed flowchart illustrating step S120 in FIG. 8.

FIG. 10 is a reference diagram illustrating a modified B+ tree node searching method according to an exemplary embodiment of the present invention by a pseudo code.

FIG. 11 is a block diagram of a modified B+ tree node searching apparatus according to an exemplary embodiment of the present invention.

### MODE FOR THE INVENTION

Hereinafter, exemplary embodiments of the present invention will be described in detail with reference to the accompanying drawings. Herein, in the description of the present invention, a detailed description of known functions and configurations incorporated herein will be omitted when it may make the subject matter of the present invention rather unclear.

The exemplary embodiments combine components and features of the present invention in a predetermined form. Each of the components or features may be considered as being selected when not explicitly mentioned. Each component or feature may be implemented without a combination with another component or feature. The exemplary embodiments of the present invention may be implemented by combining some of the components and/or features. An order of operations described in the exemplary embodiments of the present invention may be changed. Some of the components or features in any exemplary embodiment may be included in another exemplary embodiment or may be replaced with corresponding components or features in another exemplary embodiment.

The exemplary embodiments of the present invention may be implemented through various means. For example, the exemplary embodiments of the present invention may be implemented by hardware, firmware, software, or a combination thereof.

In case of the implementation by hardware, a method according to the exemplary embodiments of the present invention may be implemented by one or more of application specific integrated circuits (ASICs), digital signal processors (DSPs), digital signal processing devices (DSPDs), programmable logic devices (PLDs), field programmable gate arrays (FPGAs), a processor, a controller, a microcontroller, a microprocessor, and the like.

In case of the implementation by firmware or software, a method according to the exemplary embodiments of the present invention may be implemented in a form of modules, procedures, functions or the like for performing the above-explained functions or operations. Software codes are stored in a memory unit to be driven by a processor. The memory unit is provided inside or outside the processor to exchange data with the processor using various means known to the public.

Specific terms used in the following description are provided to help with the understanding of the present invention, and the use of the specific terms may be changed in a different form without departing from the technical idea of the present invention.

A solid state drive or solid state disk (SSD) is a data storage device using a memory chip, such as a synchronous DRAM (SDRAM) or a flash memory without using a magnetic disk. In an exemplary embodiment of the present invention, as long as the data storage device is based on the memory chip, such as the flash memory or the like, others may be used as well as the SSD. Hereinafter, the SSD will be described as an example of the data storage device.

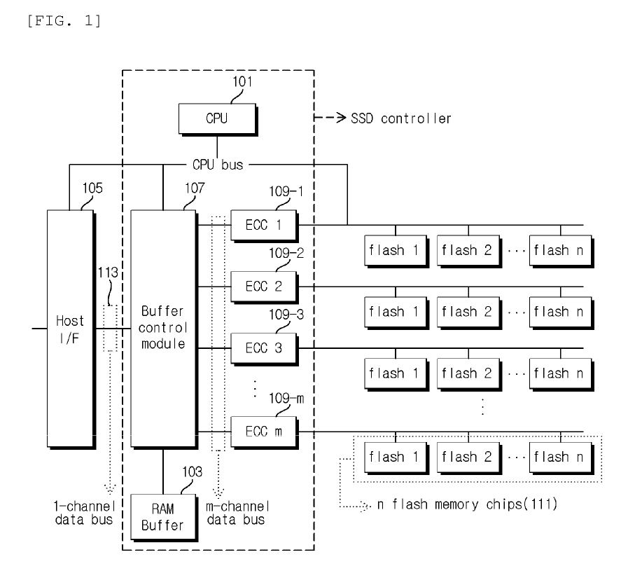

FIG. 1 is a block diagram schematically illustrating an internal configuration of a flash SSD. According to FIG. 1, the flash SSD includes a CPU 101, a RAM unit 103, a host interface unit 105, a buffer control module 107, an error correction code (ECC) module 109, and a flash memory chip unit 111. The internal configuration of the flash SSD will be schematically described with reference to FIG. 1.

When the CPU 101 instructs a data writing request, data is loaded from an external data storage unit and transferred to the buffer control module 107 via the host interface unit 105. The host interface unit 105 and the buffer control module 107 are connected to each other through at least one channel data bus 113. The CPU 101 is connected to the host interface unit 105, the buffer control module 107 and the like through a CPU bus 115. The requested data is written in the flash memory chip unit 111, and divided data for each channel is written in a plurality of flash memory chips.

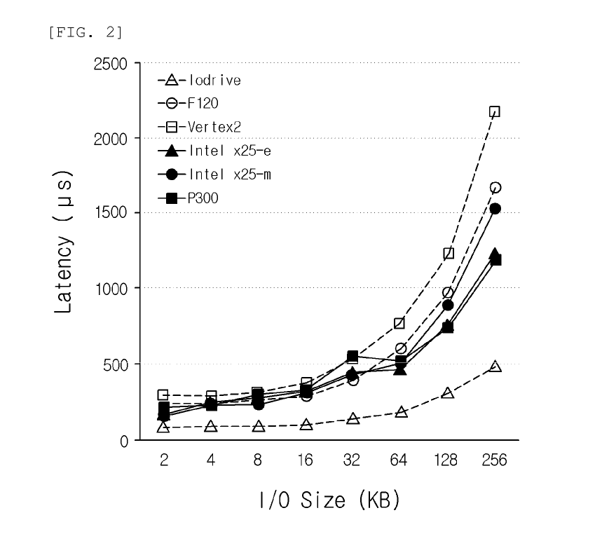

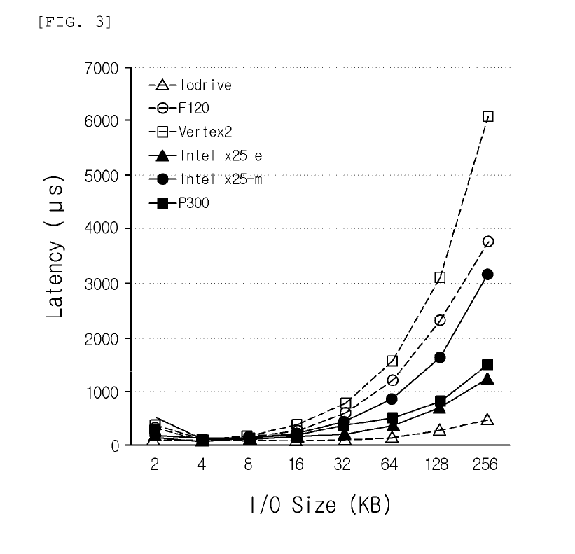

A difference due to internal parallelism of the flash SSD will be described with reference to FIGS. 2 and 3. For a benchmark of the capability according to the parallelism of the flash SSD, tests for a host interface type such as SATA II, SATA III, controllers of main SSD controller vendors (Intel Fusion-io, SandForce, Marvell and the like), and flash SSDs of flash memory types (SLC 50 nm, SLC 35 nm, MLC 35 nm, and MLC 25 nm) are implemented.

FIG. 2 is a reference diagram for describing a measurement of a delay time of a random input (read) according to an I/O size, and FIG. 3 is a reference diagram for describing a measurement of a delay time of a random input (read) according to an I/O size. The measurement is achieved by setting the I/O size to be double for each time in 2 Kb. Referring to FIGS. 2A and 2B, it may be known that a delay time according to an increase in the I/O size and an input/output (read/write) does not linearly increase. That is, it may be known that a delay time according to a 4 Kb random input/output (read/write) is almost the same as or smaller than a delay time according to a 2 Kb random input/output (read/write) and a bandwidth is improved double or more. It is because processing of a large capacity I/O is more suitable for the SSD.

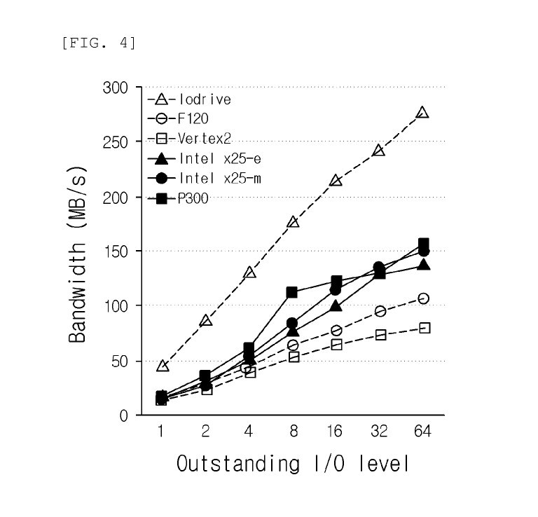

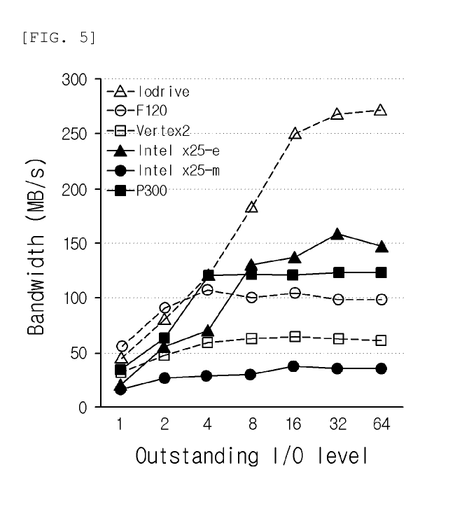

FIG. 4 illustrates a benchmark result when the input (read) is performed in a state where the I/O size is fixed to 4 Kb, and FIG. 5 illustrates a benchmark result when the output (write) is performed in a state where the I/O size is fixed to 4 Kb. It may be known that an input/output (read/write) bandwidth gradually increases in an outstanding I/O level.

The outstanding I/O level means the number of simultaneous I/O requests when a plurality of I/O requests is simultaneously transmitted. That is, when the plurality of I/O requests is simultaneously made to one SSD, a plurality of flash memory chips within the SSD can simultaneously process the I/O requests, so that a fast bandwidth (in FIG. 1, faster 10 times to 15 times in comparison with a current hard disk) proportional to the number of flash memory chips within the SSD is provided, and such a characteristic corresponds to a main I/O feature of the data storage device based on the memory chip.

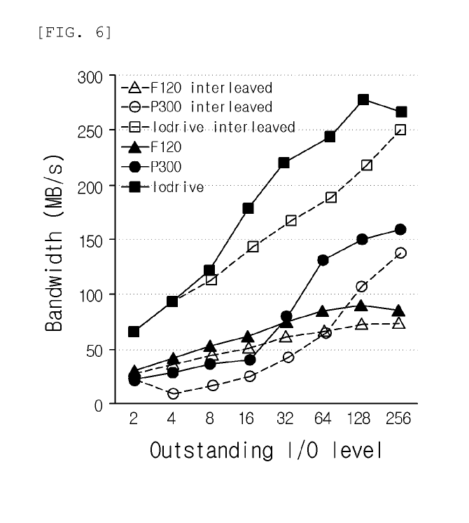

FIG. 6 illustrates a combination of the input/output in the outstanding I/O level. FIG. 3C shows that an input/output bandwidth of non-interleaved workloads is larger than an input/output bandwidth of highly interleaved workloads.

As described in FIGS. 2 and 6, in order to use parallelism of a package level, it is preferable that a size of an I/O basic unit is large. When the size of the basic I/O unit to increase the bandwidth becomes large, a delay time to process the corresponding I/O unit may become long. Therefore, the size of the basic I/O unit should be determined based on a mutual relationship between the delay time and the bandwidth expansion.

In order to use parallelism of a channel level, a plurality of I/O requests should be simultaneously transmitted to the storage device based on the memory chip, such as the flash SSD. In order to generate the plurality of I/O requests, a method of using one individual process per I/O request can be used, but the method has a big cost in generating the process. Accordingly, an asynchronous (async) I/O scheme by which one individual process can simultaneously transmit the plurality of I/O requests is used. A synchronous (sync) I/O corresponds to a type of waiting for completion of data transmission/reception and then performing another processing, and an asynchronous (async) I/O corresponds to an I/O type of performing another processing without waiting for the completion of the data transmission/reception in the input and output of the data.

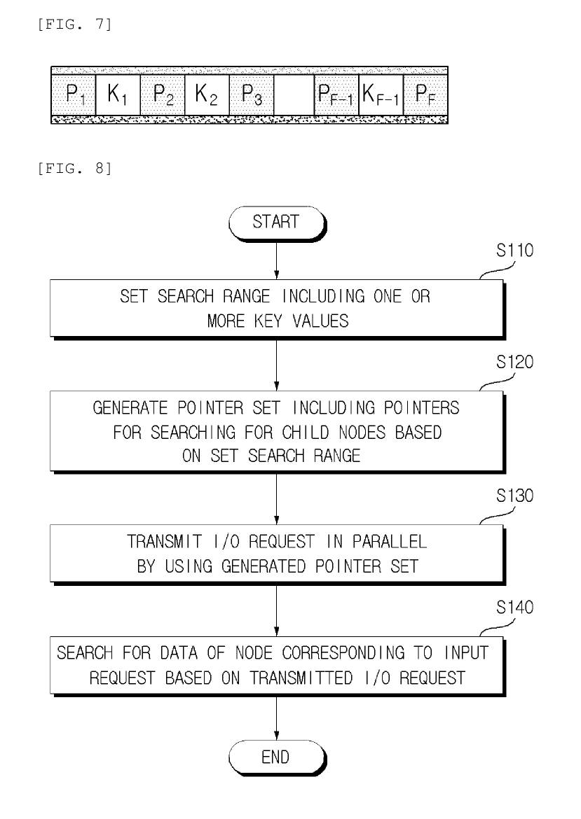

An internal node structure for a B+ tree configuration will be described with reference to FIG. 7. Pᵢ denotes an i-th pointer value, Kᵢ denotes an i-th key value (i is a natural number), and F denotes a fanout connected to nodes spread from an internal node. That is, internal nodes constituting the B+ tree include pointer values and key values indicating child nodes. Accordingly, in the present invention, associated pointers to search for child nodes related to key values refer to Pᵢ and Pᵢ₊₁ adjacent to Kᵢ.

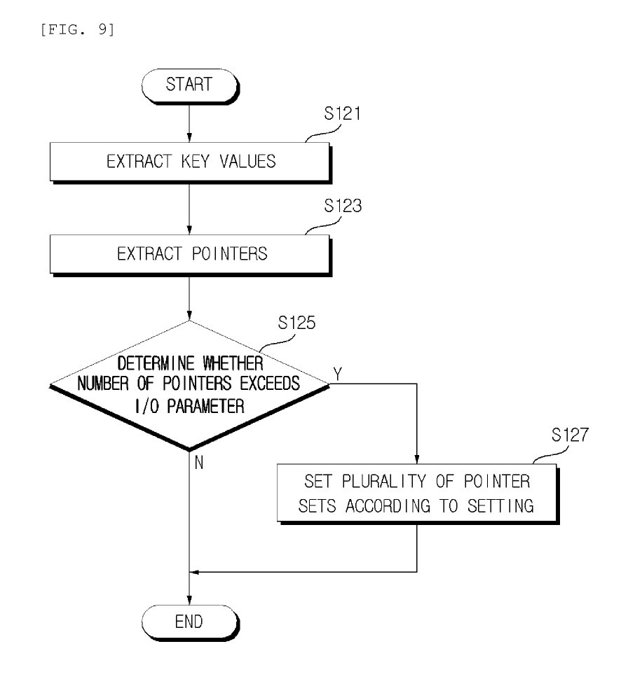

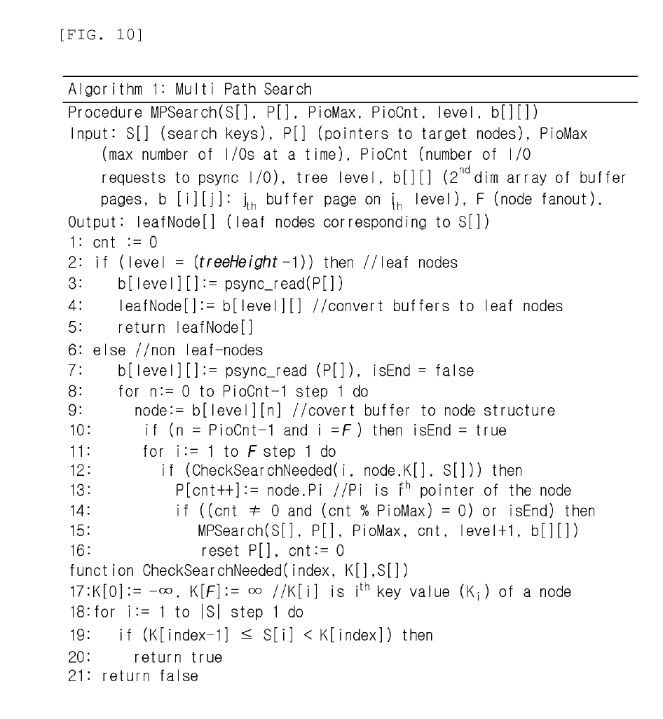

A modified B+ tree node searching method according to an exemplary embodiment of the present invention will be described with reference to FIGS. 8 and 9.

In step S110, a search range including at least one key value is set based on an input of the user. The key value refers to data which allows data of the child node to be searched based on the input of the user.

According to an exemplary embodiment of the present invention, the step of setting the search range includes a step of extracting a start value of the search range and an end value of the search range for at least one key value based on an input request of the user and a step of setting the search range having the extracted start value and end value. For example, it may be implemented such that a minimum value of the key values based on the input request of the user may be extracted as the start value of the search range, and a maximum value of the key values based on the input request of the user may be extracted as the end value of the search range. Accordingly, when a key value set according to the request of the user is {1, 2, 42, 65, 67}, a minimum value of the key value set is 1 and a maximum value of the key value set is 67, so that the search range is set as 1≦S<67.

In step S120, a pointer set including pointers for searching for child nodes is generated based on the set search range. The pointer set refers to a set of the pointers for indicating positions of the child nodes. According to an exemplary embodiment of the present invention, the step of generating the pointer set includes a step (S121) of extracting key values corresponding to the search range, a step (S123) of extracting associated pointers to search for child nodes related to the extracted key values, and a step (S125) of setting the pointer set by the extracted associated pointers according to the set I/O parameter based on a shape of the B+ tree to calculate an available memory.

In step S121, the key values included in the set search range are extracted. For example, when a key value set according to the request of the user is {1, 2, 8}, a minimum value of the key value set is 1 and a maximum value of the key value set is 8, so that the search range is set as 1≦S<8, and the key values included in the search range are set as {1, 2, 3, 4, 5, 6, 7}.

In step S123, the associated pointers to search for child nodes related to the extracted key values are extracted. As described in FIG. 5, pointers located adjacent to a corresponding key value, such as Pᵢ and Pᵢ₊₁ adjacent to the key value Kᵢ are extracted from the internal node.

In step S125, the pointer set is set by the extracted associated pointers according to the I/O parameter and the shape of the B+ tree set to calculate the available memory. The shape of the B+ tree refers to a structural characteristic of the B+ tree, such as a configuration of child nodes of the B+ tree, a height of the B+ tree, or a configuration of internal nodes of the B+ tree. According to an exemplary embodiment of the present invention, the step of setting the pointer set is performed by multiplying an I/O parameter set based on a maximum available memory use amount which can be used for performing the search and an index based on a height of the B+ tree including nodes for the search. For example, when the I/O parameter value set to perform the search is 32 and the index based on the height of the B+ tree is (treeheight-1), a memory space for I/O performance is set in the unit of 32*(treeheight-1). In the present invention, the unit of memory spaces may be implemented by a page, and may be different according to a system in which the present invention operates. The I/O parameter may be randomly set, but it is generally preferable to set the I/O parameter as about 32 when a memory allocation amount, memory availability for process processing and the like are considered.

According to another exemplary embodiment, when the number of extracted associated pointers exceeds the I/O parameter, a plurality of pointer sets is set according to a setting of the I/O parameter. In the case where the number of extracted associated pointers exceeds the set I/O parameter, when the I/O is transmitted in parallel, a maximum available memory is excessively used, thereby generating a problem in that the system is delayed, a search speed is reduced or the like. Accordingly, when the number of extracted associated pointers exceeds the set I/O parameter, a plurality of pointer sets is set. That is, the pointer set is set to be suitable for the unit of secured memory spaces by using the I/O parameter and the index based on the height of the B+ tree, and the set is repeatedly set for the remaining pointers. In the plurality of set pointer sets, the I/O request is transmitted in parallel with respect to one pointer set, a data search is performed according to the transmitted I/O request, and then the I/O request is transmitted with respect to another pointer set.

In step S130, the I/O request is transmitted in parallel by using the generated pointer set. According to an exemplary embodiment of the present invention, it may be implemented such that one or more asynchronous I/O requests are simultaneously transmitted to the data storage device by using the pointer included in the pointer set. It is preferable that the data storage device uses a memory chip having a plurality of I/O channels.

In step S140, data of the node corresponding to the input request is searched based on the transmitted I/O request. According to an exemplary embodiment of the present invention, it may be implemented such that the data of the node is searched by using a depth first search (DFS).

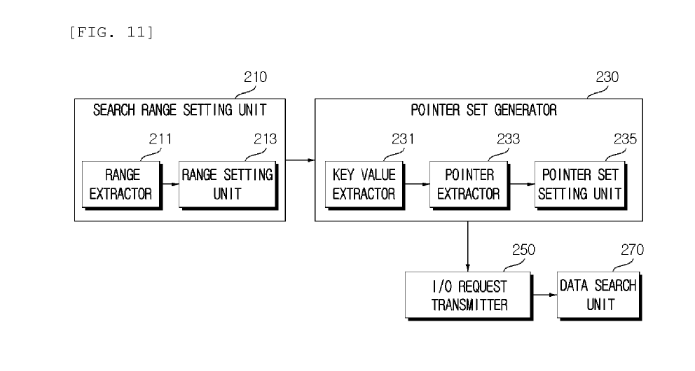

FIG. 10 illustrates a modified B+ tree node searching method according to an exemplary embodiment of the present invention by a pseudo code. A parallel searching process using the I/O parameter according to an exemplary embodiment of the present invention will be described with reference to FIG. 6. According to an exemplary embodiment of the present invention, the searching process starts with reading a root node. Subsequently, pointers indicating child nodes associated with a key value according to a request of the user are extracted, and a pointer set is generated by the extracted pointers. When an individual pointer set is smaller than the set I/O parameter (hereinafter, referred to as “PioMAX”), the B+ tree is searched by using the pointer set. When the number of associated pointers exceeds PioMAX, the above process is performed by extracting the pointers and repeatedly performing the process of generating the pointer set to generate a plurality of pointer sets. The process is similarly performed to the depth first search (DFS).

FIG. 11 is a block diagram of a modified B+ tree node searching apparatus according to an exemplary embodiment of the present invention. The B+ tree node searching apparatus according to an exemplary embodiment of the present invention includes a search range setting unit 210, a pointer set generator 230, an I/O request transmitter 250, and a data search unit 270.

The search range setting unit 210 sets a search range including one or more key values based on an input of the user. The search range setting unit 210 according to an exemplary embodiment of the present invention includes a range extractor 211 and a range setting unit 213.

The range extractor 211 extracts a start value of the search range and an end value of the search range for the one or more key values based on the input request of the user.

The range setting unit 213 sets a search range having the start value and the end value.

The pointer set generator 230 generates a pointer set including pointers for searching for child nodes based on the set search range. The pointer set generator 230 according to an exemplary embodiment of the present invention includes a key value extractor 231, a pointer extractor 233, and a pointer set setting unit 235.

The key value extractor 231 extracts key values corresponding to the set search range.

The pointer extractor 233 extracts associated pointers to search for child nodes related to the extracted key values.

The pointer set setting unit 235 sets a pointer set by the extracted associated pointers according to the set I/O parameter based on a shape of the B+ tree to calculate an available memory.

According to an exemplary embodiment of the present invention, the pointer set setting unit 235 may set the pointer set by multiplying an I/O parameter set based on a maximum available memory use amount which can be used for performing the search and an index based on a height of the B+ tree including nodes for the search.

According to an exemplary embodiment of the present invention, when the number of extracted associated pointers exceeds the I/O parameter, the pointer set setting unit 235 sets a plurality of pointer sets according to a setting of the I/O parameter and recursively transmits the I/O request with respect to the plurality of pointer sets when the plurality of pointer sets are set.

The I/O request transmitter 250 transmits the I/O request in parallel by using the generated pointer set. According to an exemplary embodiment of the present invention, the I/O request transmitter 250 may simultaneously transmit one or more asynchronous I/O requests to the data storage device by using the pointer included in the generated pointer set.

The data search unit 270 searches for data of a node corresponding to the input request based on the transmitted I/O request.

The exemplary embodiments of the present invention may be made by a computer program. Codes and code segments included in the computer program may be easily inferred by computer programmers skilled in the art. The corresponding computer program implements the exemplary embodiments by being stored in computer-readable information storage media and read and executed by the computer. The information storage media include a magnetic recording medium, an optical recording medium, and a carrier wave medium.

As described above, the present invention has been described mainly based upon the exemplary embodiments. A person with ordinary skill in the art to which the present invention pertains will understand that the present invention may be implemented in a modified form within the scope which does not deviate from the essential characteristics of the present invention. Therefore, the exemplary embodiments disclosed in the above should be considered from an explanatory point of view, not a limited point of view. The scope of the present invention is defined by the claims, not the foregoing description, and all of the differences within the scope equivalent thereto should be interpreted to be included in the scope of the present invention.

1. A modified B+ tree node searching method comprising:
setting a search range including one or more key values based on an input of a user;
generating a pointer set including pointers for searching for child nodes based on the set search range;
transmitting an I/O request in parallel by using the generated pointer set; and
searching for data of a node corresponding to a request for the input based on the transmitted I/O request.

2. The modified B+ tree node searching method of claim 1, wherein the setting of the search range comprises:
extracting a start value of the search range and an end value of the search range for the one or more key values based on the request for the input of the user; and
setting a search range having the start value and the end value.

3. The modified B+ tree node searching method of claim 2, wherein a minimum value of the key values based on the request for the input of the user is extracted as the start value of the search range, and a maximum value of the key values based on the request for the input of the user is extracted as the end value of the search range.

4. The modified B+ tree node searching method of claim 1, wherein the generating of the pointer set comprises:
extracting key values corresponding to the set search range;
extracting associated pointers to search for child nodes related to the extracted key values; and
setting a pointer set by the extracted associated pointers according to an I/O parameter set to calculate an available memory and a shape of a B+ tree.

5. The modified B+ tree node searching method of claim 4, wherein the setting of the pointer set comprises setting the pointer set by multiplying the I/O parameter set based on a maximum available memory use amount which can be used for performing a search and an index based on a height of the B+ tree including nodes for the search.

6. The modified B+ tree node searching method of claim 4, wherein the setting of the pointer set comprises setting a plurality of pointer sets according to a setting of the I/O parameter when a number of extracted associated pointers exceeds the I/O parameter.

7. The modified B+ tree node searching method of claim 6, wherein the transmitting of the I/O request comprises recursively transmitting the I/O request for the plurality of set pointer sets.

8. The modified B+ tree node searching method of claim 1, wherein the transmitting of the I/O request comprises simultaneously transmitting one or more asynchronous I/O requests to a data storage device by using a pointer included in the generated pointer set.

9. The modified B+ tree node searching method of claim 8, wherein the data storage device uses a memory chip having a plurality of I/O channels.

10. The modified B+ tree node searching method of claim 1, wherein the searching for the data of the node comprises searching for the data of the node by using a depth first search (DFS).

11. A modified B+ tree node searching apparatus comprising:
a search range setting unit for setting a search range including one or more key values based on an input of a user;
a pointer set generator for generating a pointer set including pointers for searching for child nodes based on the set search range;
an I/O request transmitter for transmitting an I/O request in parallel by using the generated pointer set; and
a data search unit for searching for data of a node corresponding to a request of the input based on the transmitted I/O request.

12. The modified B+ tree node searching apparatus of claim 11, wherein the search range setting unit comprises:
a range extractor for extracting a start value of the search range and an end value of the search range for the one or more key values based on the request of the input of the user; and
a range setting unit for setting a search range having the start value and the end value.

13. The modified B+ tree node searching apparatus of claim 11, wherein the pointer set generator comprises:
a key value extractor for extracting key values corresponding to the set search range;
a pointer extractor for extracting associated pointers to search for child nodes related to the extracted key values; and
a pointer set setting unit for setting a pointer set by the extracted associated pointers according to an I/O parameter set based on a shape of a B+ tree to calculate an available memory.

14. The modified B+ tree node searching apparatus of claim 13, wherein the pointer set setting unit sets the pointer set by multiplying the I/O parameter set based on a maximum available memory use amount which can be used for performing a search and an index based on a height of the B+ tree including nodes for the search.

15. The modified B+ tree node searching apparatus of claim 13, wherein the pointer set setting unit sets a plurality of pointer sets according to a setting of the I/O parameter when a number of extracted associated pointers exceeds the I/O parameter, and the I/O request transmitter recursively transmits the I/O request for the plurality of set pointer sets.

16. The modified B+ tree node searching apparatus of claim 15, wherein the I/O request transmitter simultaneously transmits one or more asynchronous I/O requests to a data storage device by using a pointer included in the generated pointer set.

17. A computer-readable recording medium for recording the modified B+ tree node searching method of claim 1 executable by a computer.
